(19) United States
(12) Patent Application Publication
(10) Pub. No.: US 2011/0147318 A1
(43) Pub. Date: Jun. 23, 2011

(54) MINIATURE OZONE GENERATOR AND USE THEREOF FOR PURIFYING WATER

(75) Inventors: Amir SALAMA, Shefford (CA); Marianne SALAMA, Shefford (CA)

(73) Assignee: OZOMAX INC., Shefford (CA)

(21) Appl. No.: 13/017,334

(22) Filed: Jan. 31, 2011

Related U.S. Application Data
(62) Division of application No. 12/273,459, filed on Nov. 18, 2008, now abandoned.
Application No. 12/273,459 is a continuation of application No. PCT/CA2007/000724, filed on Apr. 27, 2007.

(30) Foreign Application Priority Data
May 18, 2006 (CA) 2547373

(51) Int. Cl. C02F 1/78; C25B 1/13; C25B 9/00

(52) U.S. Cl. 210/748.19; 210/192

(57) ABSTRACT

The present invention is concerned with a miniature ozone generator device for purifying water. The device includes a printed circuit board having an ozone producing circuit printed on it which includes anodes and cathodes alternatively printed and connected in parallel relationship to each other and to a power supply device. The electrodes have rough (non-smooth) surfaces. In use, when the ozone generator is plunged into a vessel containing the water to purify, this leads to a coalescence of hydrogen bubbles produced by the cathodes into larger hydrogen bubbles, and thus to a higher production of ozone by the anodes.

### CROSS-RELATION APPLICATION

The present case is a divisional of U.S. patent application Ser. No. 12/273,459 filed Nov. 18, 2008, which application is a continuation of PCT/CA2007/000724 filed Apr. 27, 2007 which claims priority to Canadian Patent No. 2,547,373 filed on May 18, 2006, the entire contents of which are incorporated by reference herein in their entireties.

### TECHNICAL FIELD

The present invention relates to a miniature device for generating ozone in-situ in water in order to remove therefrom a large variety of pollutants, especially organic pollutants, in addition to bacteria and viruses, and thus make the water drinkable.

The invention is not limited to the purification of water, but may pertain to any sort of liquid solution containing water such as fruit juice, milk or dairy liquids, tea, coffer, or the like.

In other words, the present invention relates to a miniature water purifier printed on a printed circuit board (PCB) which can work with a very low voltage current produced by a power supply integrated to the PCB or by an external power source, such as batteries, solar panels, electric transformer, or the like and thus be easily portable.

The size of the miniature ozone generator can be as small as a stamp and energetically self-sufficient when it is directly plunged into a glass or a bottle of water to purify it.

The present invention also relates to the use of the miniature water purifier directly in a glass of water or integrated to a water bottle, and methods for doing the same.

### BACKGROUND

In order to carry out purification of water without the use of biocides such as chlorine and other chemicals, it is well known in the art to use ozone (O₃) as a disinfectant. Ozone is usually prepared outside the medium (water) and then injected inside the water by means of injectors or bubbling in a contact column. Such makes the process bulky and costly as it involves the use of several devices.

Production of ozone (O₃) by electrolysis is a well-known process since the 19^{th} century. By way of example, U.S. Pat. Nos. 5,250,177 and 5,154,895 disclose devices for generating ozone by electrolysis. The so generated ozone is then used for the purification of water. U.S. Pat. No. 4,728,441 discloses a device wherein ozone is produced from oxygen generated by electrolysis. However, the so generated ozone is recovered and used outside of the device, U.S. Pat. Nos. 4,416,747; 5,205,994; 5,686,051; 5,203,972 and 5,779,865 disclose devices using solid electrolyte to produce ozone. U.S. Pat. No. 3,623,970 discloses a device for producing a stream of ozone by electrolysis of water and conversion of the oxygen that is so produced into ozone.

It is further known that ozone can be produced via UV light, such as in U.S. Pat. Nos. 4,189,363 (BEITZEL) and 4,992,169 (IZUMIYA).

It is further known that the efficiency of an apparatus using U.V. light to destroy micro-organisms can be enhanced if ozone is mixed with the water to be purified, such as in U.S. Pat. No. 5,266,215 (ENGELHARD).

In U.S. Pat. No. 5,151,252 (MASS), there is disclosed a photochemical reactor for the treatment of a fluid polluted with photoreactants components. This patent discloses that the walls of the reactor in the treatment region may be coated with a catalyst in order to increase the rate of secondary reactions that occur with reaction products produced by the initial photochemical reaction.

Salt bridges with membranes were used to separate the ozone, oxygen and mixed oxidants produced around the anode from the hydrogen produced at the cathode. Platinum (Pt) wires were used as the anode and as the cathode. The idea of membrane separation was also described and improved upon by the present inventor in U.S. Pat. No. 6,180,014 (SALAMA) wherein relatively higher voltages were used to get sufficient ozone production than the new inventive device described hereafter. Water purification systems are generally large devises, uneasy to carry and travel with. It would therefore be a significant advance in the art of water purification system to provide a portable, miniature and reusable water purification system, working with a low voltage power supply by keeping the same purification efficiency and usable for purifying the water of a glass or a bottle within a few second period of time.

Clearly, room for improvements always exists in this area of technology.

### SUMMARY

The object of the present invention is based on the discovery that the size of the hydrogen bubbles produced during the electrolysis strongly influences the final amount of ozone. The bigger are the bubbles, the higher is the amount of ozone, the better and faster is the purification of the water.

It is therefore a first object of the present invention to provide an ozone generator device for purifying water which includes a printed circuit board (PCB) having a first and second surface, and an ozone producing circuit (OPC) printed on the first surface of the PCB. The OPC includes a plurality of anodes and cathodes that are alternatively printed on the PCB and connected in parallel relationship to each other and to a power supply device. Anodes and cathodes of the OPC have rough (non-smooth) surfaces, whereby, in use, when the ozone generator device is plunged into a vessel containing water to be purified, the cathodes produce hydrogen bubbles and the anodes produce ozone and mixed oxidants, and wherein due to the non-smooth surfaces, the cathodes lead to a coalescence of the hydrogen bubbles into larger hydrogen bubbles, and thus to a higher concentration of ozone.

The electrolysis of water leads to the creation of hydrogen gas (H₂) at the anodes (negative poles), and oxidants at the cathodes (positive poles). The oxidants include ozone gas (O₃) and mixed oxidants including oxygen gas (O₂), peroxides, hydroxyl radicals, or the like. The contact between H₂ and O₃ has to be limited in order to enhance the production of O₃ in water and therefore enhance the water purification.

Thus, it has been discovered that the roughness of the surfaces of the anodes allows the production of a higher amount of ozone comparatively to smooth surfaces under the same voltage current.

Indeed, non-smooth surfaces have a higher effective surface in contact with the water and allow the production of larger hydrogen bubbles by coalescence of the smaller hydrogen bubbles normally produced by smooth surfaces, and thus greatly reducing the reactivity surface between the hydrogen bubbles and the oxidants produced by the cathodes, such as ozone.

Consequently, the unwanted parasite reaction of the ozone with the hydrogen occurring between the electrodes is considerably reduced, leading to a higher production of ozone by using a lower voltage current and a very efficient purification of the water.

Anodes and cathodes of the ozone generator device according to the invention are preferably made of or plated with: activated or non-activated carbon fibers or nanotubes, metals or alloys of these metals selected from columns 3 to 13 (also named IB to VIIIB and IIIB) of the Periodic Table.

More preferably, the cathode is made or coated with a metal or a coating capable of absorbing hydrogen such as: metals or alloys from subgroups IIIB, IVB, VB, VIIB or VIIIB of the periodic table of elements, more preferably selected from, but not limited to, palladium, palladium alloys, magnesium alloys, and titanium alloys; special activated carbons, or other electrically conductive or H₂ absorbing materials known in the art.

It has to be understood that the size and/or the number of ozone generator device according to the invention are selected according to the amount and quality of water to be purified.

The ozone generator device may have different configurations which are mainly based on different ways to electrically power the electrodes.

1) More particularly, in accordance with a first aspect of the invention, the power supply is integrated to the printed circuit board. In that case, the power supply may include a plurality of galvanic cells printed on the first surface of the printed circuit board (PCB) and connected in series relationship to each other.

The galvanic cells are made of any sort of metal combinations well known in the art of making galvanic cells. Preferably, the metal combination is selected from Pt/Al, Pt/Ti, Pt/Mn and Pt/Mg.

Otherwise, the power supply device may include at least a battery and/or at least a silicon solar panel fixed on one of the surfaces of the printed circuit board.

Such a first aspect of the invention may allow a direct use of the ozone generator device by plunging it into a vessel, such as a glass, a bottle, or the like, containing the water to be purified.

Accordingly, the method for purifying the water contained into the selected vessel includes the steps of: a) plunging the ozone generator device into the vessel containing water to be purified, the ozone generator device being defined according to the first aspect of the invention detailed above; and b) waiting for an adequate period of time in order to let the ozone generator device producing ozone and purifying the water.

An optional step of gently shaking the vessel may be added to the above mentioned method in order to reduce the adequate period of time needed to purify the water.

By “adequate period of time”, it has to be understood a period of time that will be depending on the power of the device and the amount and quality of water to be efficiently and safely treated.

II) In accordance with a second aspect of the invention, the power supply device is exterior to the printed circuit board and linked to the ozone producing circuit via electric wires.

In accordance with this second aspect of the invention, the power supply device may include a plurality of galvanic cells as defined in part I) above, printed on another printed circuit board and connected in series relationship to each other. As aforesaid, the power supply device is then linked to the ozone producing circuit via electric wires. In use, the power supply is turned on by plunging it into another vessel containing an electrolyte solution.

As aforesaid, the electrolyte solution may be water or a mix of water with one or more salts such as sodium chloride.

Accordingly, the method for purifying the water contained into the selected vessel includes the steps of: a) plunging into water to be purified the zone generator device as defined above; h) plunging the power supply of the ozone generator device in another vessel containing an electrolyte solution; and c) waiting for an adequate period of time in order to let the ozone generator device producing ozone and purifying the water.

In accordance with this second aspect of the invention, the external power supply device may also include a battery or a plurality of batteries, rechargeable or not.

The power supply device may further include an electric transformer alimented by a public electric system or an individual electric system, such as a solar panel, a windmill or the like. This configuration may be particularly useful when the device is used in a region where public electricity is not available.

In all cases, the power supply is linked to the ozone producing circuit via electric wires. In use, the power supply is turned on for producing current and making the ozone generator device producing ozone.

In accordance with this second aspect of the invention, the method for purifying water includes the steps of: a) plunging the zone generator device according to this second aspect of the invention into water to be purified; b) turning on the power supply of the ozone generator; and c) waiting for an adequate period of time in order to let the ozone generator device producing ozone and purifying the water.

Here again, an optional step of gently shaking the vessel may be added to the above mentioned method in order to reduce the adequate period of time needed to purify the water.

According to a preferred embodiment of the invention, the ozone generator device may also includes on the first surface of the PCB and underneath the ozone producing circuit, a thin film heating element connected to the power supply.

Optionally, the ozone generator device may also include on the second surface of the PCB another thin film heating element also connected to the power supply. In use, the thin film heating elements produce heat. The production of heat leads to the regeneration of the cathodes.

According to another preferred embodiment of the invention, the ozone generator device may further include a second ozone producing circuit printed on the second surface of the printed circuit board (PCB). This second ozone producing circuit being identical to the ozone producing circuit printed on the first surface of the PCB and defined above.

According to another preferred embodiment of the invention, the ozone generator device may further include a plurality of lights or light emitting diodes (LEDs) fixed on the printed circuit board, and also connected to the power supply, in order to help the ozone in the purification of the water.

Production of light is well known as facilitate the purification of water by ozone and enhance the formation of O₃ from O₂ and mixed oxidants such as, but not limited to hydroxyl radicals or peroxides. To efficiently enhance the water purification, the lights or LEDs preferably have a wavelength from about 1 nm (far ultra-violet light) to 600 nm (green light).

The present invention also concerns a portable ozone generator device for purifying water including a plurality of ozone generator device as defined above. The miniature devices may be arranged in a geometrical manner, such a pyramid, a cube or the like. Each face of the geometry includes a miniature ozone generator device according to the invention.

The present invention also concerns the use of the ozone generator device as defined above, for purifying water and to make it drinkable.

The ozone generator device according to the present invention has the advantage to be small enough to be easily transported and plunged into a glass, a jug or a bottle containing the water to be purified. The ozone generator device may be adapted and permanently fixed inside the vessel for purifying the water every time the vessel is filled up with water.

Therefore, the present invention also concerns the use of the device as defined above in a vessel containing water to be purified. Preferably, this vessel is a bottle. More preferably, the bottle has a neck including a drinking nipple, and optionally a filter. The filter may be made of granular activated carbon, carbon block, membrane filter or resins.

Preferably, the above mentioned bottle may have an internal volume and include a separating wall to separate this internal volume into a top volume containing water to be purified and a bottom volume containing an electrolyte solution. The ozone generator device as defined above may be inserted through the separating wall. Indeed this separating wall may include a hole sized to fit the ozone generator device. Once installed, the ozone producing circuit of the ozone generator remains into the top volume of the bottle and the power supply device remains into the bottom volume.

Here again, the electrolyte solution contains water or a mix of water and a salt such as sodium chloride.

More preferably, the above mentioned separating wall may be a membrane allowing the water to go through the membrane and maintaining the salt into the bottom volume.

Optionally, the above mentioned bottle may have an internal volume and a bottom, the bottle including a compartment fixed to its bottom and hermetically separated from the internal volume of the bottle containing water to be purified. By being hermetic, the compartment may contain an electric power supply, such as at least one battery, connected to the ozone producing circuit of the ozone generator through the separating wall.

The present invention will be better understood upon reading the following non-restrictive description of preferred embodiments thereof, made with reference to the accompanying drawings.

### BRIEF DESCRIPTION OF THE FIGURES

FIG. 1A is a schematic representation of a miniature ozone generator according to a preferred embodiment of the present invention plunged into a glass of water.

FIG. 1B is a schematic representation of a miniature ozone generator with galvanic cells internal power supply according to a preferred embodiment of the present invention.

FIG. 2 is a schematic representation of a miniature ozone generator with external galvanic cells power supply according to another preferred embodiment of the present invention.

FIG. 3 is a schematic representation of the miniature ozone generator as illustrated in FIG. 1B plunged into a bottle of water having a filter into a nipple.

FIG. 4 is a schematic representation of an ozone generate with internal power supply according to another preferred embodiment of the present invention plunged into a bottle of water having a filter and a compartment containing an electrolyte solution.

FIG. 5 is a schematic representation of a miniature ozone generator with external power supply according to a preferred embodiment of the present invention plunged into a bottle of water having a filter and a power supply integrated to the bottle.

### DETAILED DESCRIPTION

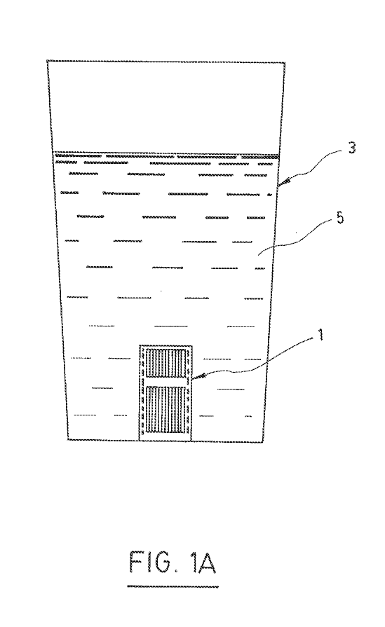

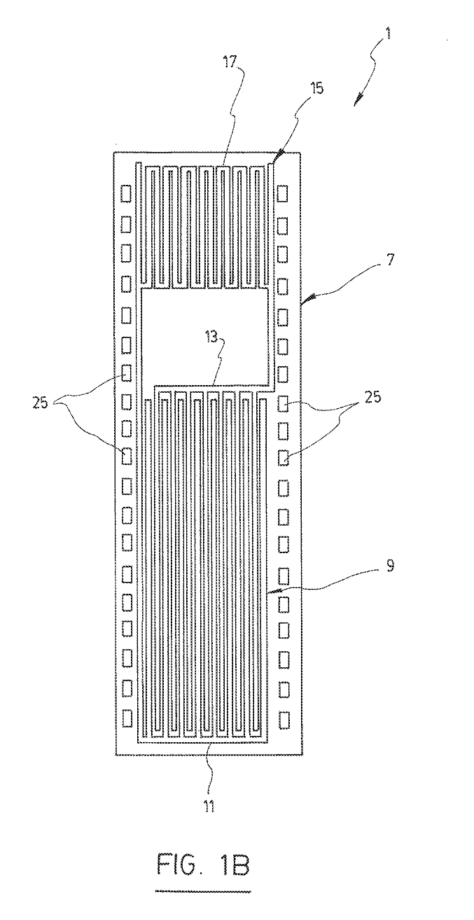

As illustrated in FIG. 1A, the ozone generator device 1 for purifying water is small enough to be plunged into a vessel, such as a glass 3, containing water 5. The miniature ozone generator according to a preferred embodiment of the invention is better illustrated and detailed in FIG. 1B wherein one can see that, the ozone generator device 1 for purifying water 5 contains a printed circuit board 7, named PCB hereinafter.

The PCB 7 can be made of ceramic, polymer (such as polycarbonate or other), glass, anodized aluminum, or any sort of substrate known in the art of printed circuit board.

On the PCB 7, an ozone producing circuit 9, referred as OPC hereinafter, has been printed. The OPC is constituted of a plurality of anodes 11 and cathodes 13 printed on the PCB 7 and connected in parallel relationship to each other to a power supply device 15.

According to the preferred embodiment illustrated in FIG. 1B, the power supply 15 is constituted of a plurality of galvanic cells 17 printed on the same PCB 7 than the OPC 9, and connected in series relationship to each other and to the OPC. Once the ozone generator 1, and therefore together with the galvanic cells 17, are plunged into the water 5, the galvanic cells 17 produce a current, the voltage of which is sufficient to make the OPC 9 producing ozone and purifying the water. In that case, the water to be treated serves as electrolyte solution.

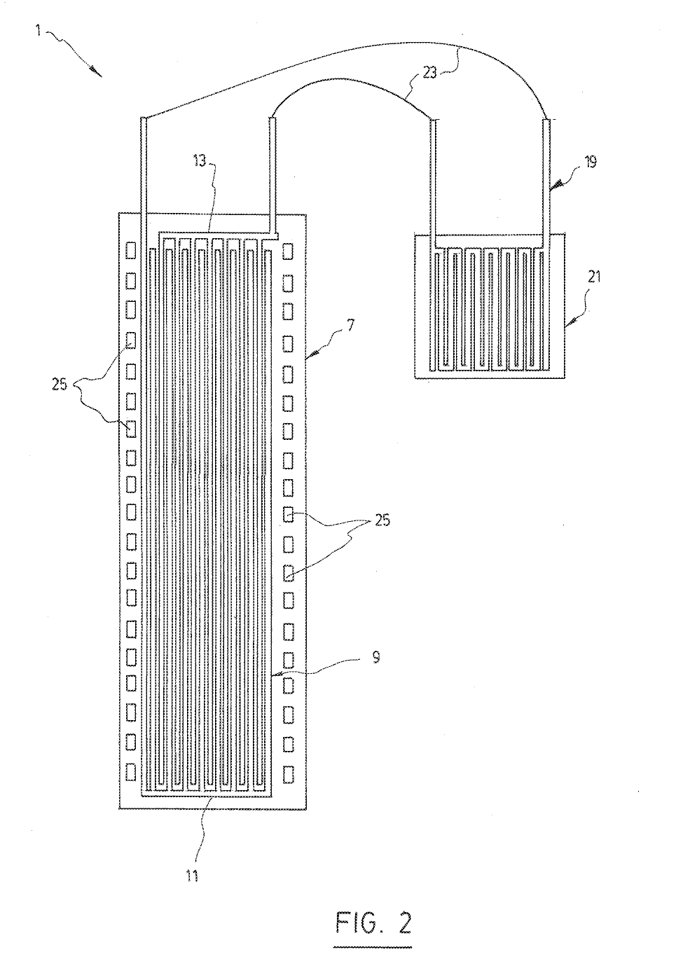

FIG. 2 illustrates an ozone generator device 1 for purifying water according to another preferred embodiment of the invention, which is quite similar to the device illustrated in FIG. 1B, except that the power supply is an external power supply device 19 printed on another PCB 21 independent of the first PCB 7. The external power supply device 19 is thus linked to the OPC 9 via electric wires 23. In use, the external power supply 19 is plunged into another vessel containing water or an electrolyte solution, preferably an electrolytic solution (not illustrated in FIG. 2).

The lines thickness of the galvanic cells 17, such as the ones illustrated in FIG. 1B or 2, can be of any range but preferably between 1.27 μm (50 micro-inches) to 1.27 mm (50 milli-inches). The cells are made of any combination of metals provided that enough cells may be connected in series to provide the required electromotive force (EMF) on the OPC 9. The metal combinations include Pt/Al, Pt/Ti, Pt/Mn, Pt/Mg or any sort of combination of metals well known in the art of galvanic cells. Other possible metal combinations can be used, such as the ones described in Table 2, on page 776, of “Modern Electroplating”, 3^{rd} Edition by THE ELECTROCHEMICAL SOCIETY INC., Princeton, N.J., Published by Wiley Interscience, 1974.

As it is well known, the electrolysis process of the OPC 9 also produces molecular hydrogen (H₂) at the cathodes 13. It is well known that H₂ easily reacts with ozone (O₃) produced at the anodes 11 for making water (H₂O). In order to minimize the effect of H₂ on the production of ozone, the surfaces of the anodes 11 and cathodes 13 of the OPC 9 have been made rough. As aforesaid, the roughness of the surfaces leads to a coalescence of tiny hydrogen bubbles into larger hydrogen bubbles. These larger hydr bubbles have a much smaller effective surface area, thousands of times smaller than tiny hydrogen bubbles. These larger hydrogen bubbles are orders of magnitude less reactivity with the ozone and mixed oxidants produced at the anodes 11, even if intermixing occurs with the ozone. In other words, these larger bubbles will produce less soluble hydrogen gas (H₂) in the water, hence less parasite reaction with O₂, O₃ and other mixed oxidants like peroxides, hydroxyl radicals. It results a higher production of ozone by the OPC 9 to purify the water.

The lines thickness of the ozone producing circuit OPC 9, namely the electrodes 11, 13 may be of any width, preferably from 0.1 μm and 100 μm. The space between the lines can be of any value, preferably from 0.1 μm to 100 μm. The electrodes are made of compound selected from columns 3 to 14 of the Periodic Table. Preferably, the electrodes are made of plated Pt, Pd, Au or separate or other in combination by rough plating or dendritic type electroplating.

The ozone generator device illustrated in FIG. 1 is thus energetically self-sufficient. It has also a very light weight and a small size, due to the fact that the miniature portable ozone generator device may be constructed using thin film technology.

Ozone and mixed oxidants are formed in situ using anodes made of plating platinum family group metal such as palladium, rhenium, rhodium; gold on a rough surface or using dendritic plating; or activated or non-activated carbon fibers or nanotubes.

The hydrogen produced at cathodes 13 may be limited or removed to prevent its scavenging effects on the ozone and mixed oxidants produced at the anode. To do so, the cathodes are made of metal and alloys from the Subgroup IIIB, IVB, VB, VIIIB of the Periodic Table, such as palladium, palladium alloys or magnesium alloys.

The cathodes can be also made of special activated carbons or other electrically conductive or H₂ absorbing materials. The hydrogen absorbing capability of the cathode may be regenerated by including a thin film heating element on the back of the substrate or underneath the electrolytic area where hydrogen and ozone/mixed oxidants are produced.

As aforesaid, cathodes and anodes of the ozone producing circuit (OPC) can also be made of special nano-technology processes to enhance the formation of ozone and absorb the hydrogen. This will also enhance the formation of larger hydrogen bubbles, which with a smaller surface area, will minimize their scavenging effect on the oxygen and ozone/mixed oxidants produced.

As also aforesaid, the ozone generator illustrated in FIG. 1 is self-powered by incorporating galvanic cells 11 on the PCB 3 and using the water 13 to be treated as electrolyte. The current production is possible thanks to the small distances between the metals. In this way, ozone and mixed oxidants are produced at high concentrations due to the small distances between the electrodes in the OPC.

The production of ozone and other oxidative compounds is increased due to the roughness or dendrite plating of the anodes and cathodes, which increase the effective surface area of the electrodes.

The use of precious metals for making the electrodes provides a high protection against chemicals, oxidation and rust and thus making the device long lasting.

Furthermore, thin film and printed circuit board technology, thin film photolithography, thick film and conductive paste printing technologies allow the manufacture of the device at low cost and thus a mass production of it.

The device according to the present invention can be single-sided or double-sided for enhanced performance or extended life by covering and using each side at a time separately.

A plurality of single-sided device may be installed in a geometrical manner such as a pyramid, a cube or the like.

The PCB can be from a few millimeters wide to several inches wide depending on the volume and quality of water to be treated. Its length can be from a few millimeters to several inches long as well. This is made possible thanks to photolithographic technology for printing the electrodes on the PCB.

As illustrated in FIGS. 1B and 2, miniature lights or LEDs 25 can also be introduced on the PCB 7. As aforesaid, production of a light with a wavelength from 1 to 600 nm, is well known as facilitating the purification of water by ozone and enhance the formation of O₃ from O₂ and mixed oxidants such as, but not limited to hydroxyl radicals or peroxides.

According to another preferred embodiment of the present invention, not illustrated in the figures, the OPC can also be externally powered using batteries such as small watch-sized batteries, AAA batteries, AA batteries, or silicon solar panels integrated on the PCB.

The ozone generator device according to the invention may also be used directly in a bottle in order to purify the water contained in this bottle.

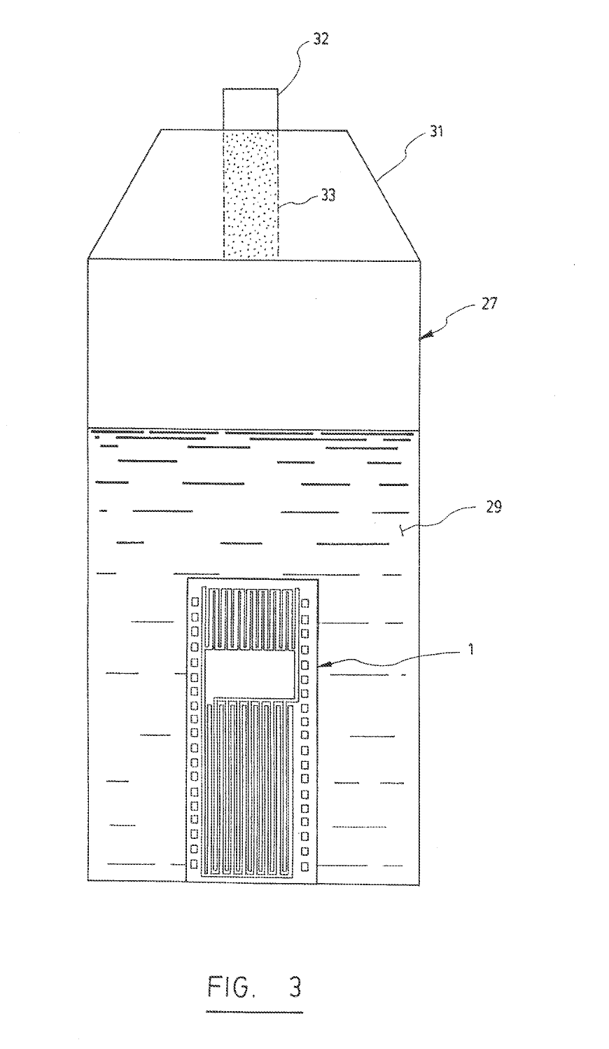

As illustrated in FIG. 3, the ozone generator device 1 is placed in bottle 27 containing water 29. Preferably, the bottle may include a cap 31 having a drinking nipple 32 equipped with a filter 33. This filter can be granular activated carbon, carbon block, membrane filter, resin or the like. The purification of the water will be enhanced by the use of the ozone generator device 1 combined with the use of the filter 33. The ozone generator device is self-powered once the ozone generator containing the galvanic cells is plunged into the water 29 of the bottle 27. In order purify the water contained in a bottle, the ozone generator device should have a bigger size than the ozone generator device illustrated in FIG. 1A and used to purify the water of a small glass.

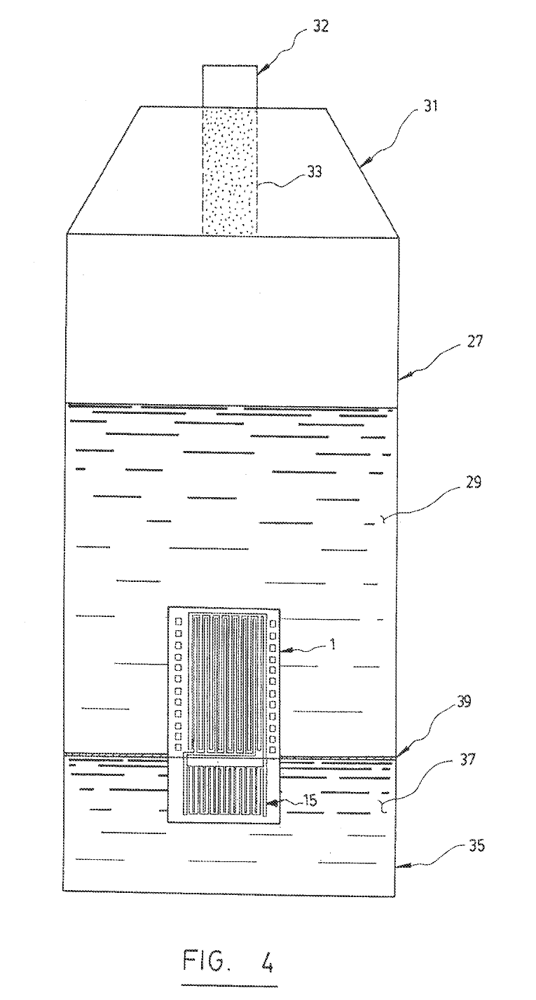

According to another preferred embodiment of the invention illustrated in FIG. 4, the ozone generator device 1 may be also used in a drinking bottle 27, having the particularity to have a compartment 35 containing an electrolyte 37. The compartment 35 is separated from the rest of the bottle containing water 29 by a membrane 39. The membrane is permeable to the water but impermeable to salts contained in the electrolyte solution 37. The ozone generator device 1 is placed through the membrane. The power supply 15 is plunged into the compartment 35 containing the electrolyte 37. The ozone producing circuit 9 is plunged into the water to be treated. The presence of the compartment containing electrolyte enhances the production of electricity and therefore, ameliorates the production of ozone into the water to be treated.

The bottle 27 as illustrated in FIG. 4 may also contain a drinking nipple 32 having a filter 33 made of granular activated carbon, carbon block, membrane filter, resin or the like.

The electrolyte solution 37 contained in the compartment 35 may be water, tap water or a salt solution such as table salt (NaCl) or the like. In the case where the water to be treated is conductive enough, the compartment 35 may be filled with the same water to be treated which reacts as an electrolyte in order to power the ozone generator device.

According to another preferred embodiment illustrated in FIG. 4, the membrane 39 may be a solid and hermetic wall impermeable to liquids or salts. In use, the compartment 35 will be first filled with the electrolytes or water, and then the wall will be placed in the bottle 27.

In all cases, the membrane or wall 39 has a hole sized to fit hermitically with the ozone generator device and fixed it through the membrane or wall.

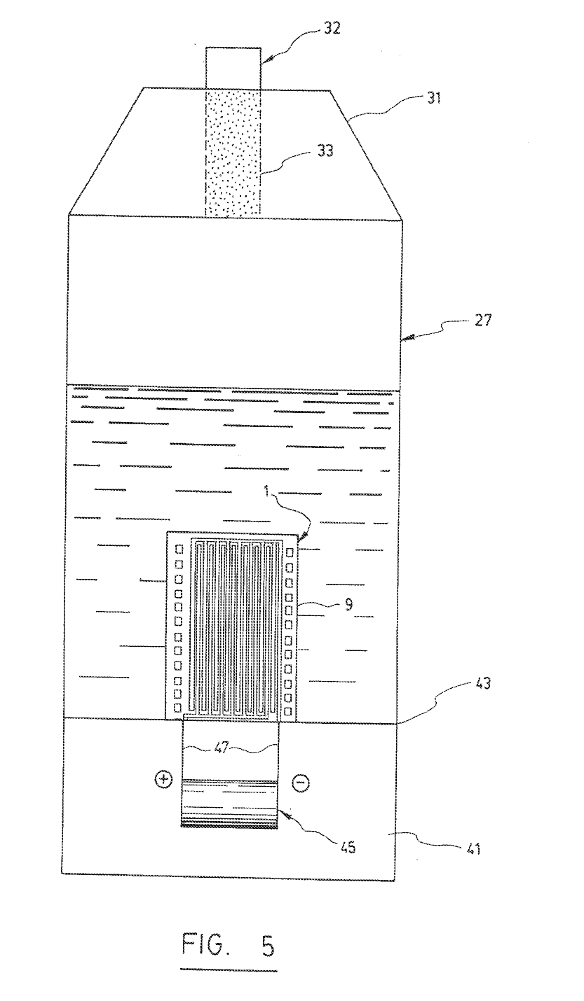

FIG. 5 illustrates another preferred embodiment of the invention wherein the ozone generator device 1 is placed into a bottle 27 containing a compartment 41 placed at the bottom of the bottle 43. This compartment 41 includes a power supply 45 directly connected to the ozone producing circuit 9 of the ozone generator device 1 via electric wires 47 through the bottom 43.

The power supply 45 may be a transformer transforming high voltage electricity (such as 110 or 220 volts) to a low voltage current adapted to power the ozone generator 1. As illustrated in FIG. 5, the power supply device may also be a battery. It may also be a plurality of batteries, such as small watch ties batteries. AAA batteries or the like.

As illustrated in FIGS. 4 and 5, the bottle 27 may also have a drinking nipple 32 installed on the cap 31 including a filter 33. As aforesaid, this filter 33 can be granular activated carbon, carbon block, membrane filter, resins or the like.

Although the present invention has been explained hereinabove by way of a preferred embodiment thereof, it should be pointed out that any modifications to this preferred embodiment within the scope of the appended claims is not deemed to alter or change the nature and scope of the present invention.

What is claimed is:

1. An ozone generator device for purifying water, the device including:
a printed circuit board having a first and second surface;
a power supply device integrated to the printed circuit board, the power supply device including a plurality of galvanic cells printed on the first surface of the printed circuit board and connected in series relationship to each other;
an ozone producing circuit printed on the first surface of the printed circuit board, the ozone producing circuit including a plurality of anodes and cathodes that are alternatively printed on the printed circuit board and being connected in parallel relationship to each other and to the power supply device, the anodes and cathodes having non-smooth surfaces; and
on the first surface of the printed circuit board, underneath the ozone producing circuit, a thin film heating element connected to the power supply;
wherein, when the ozone generator is plunged in a vessel containing water to be purified, the cathodes produce hydrogen bubbles and the anodes produce ozone and mixed oxidants; and
wherein, due to the non-smooth surfaces, the cathodes lead to a coalescence of the hydrogen bubbles into larger hydrogen bubbles, and thus to a higher production of ozone.

2. The ozone generator device according to claim 1, wherein the anodes and cathodes are made of or plated with activated or non-activated carbon fibers or nanotubes.

3. The ozone generator device according to claim 1, wherein the anodes and cathodes are made of or plated with metals or alloys of the metals selected from columns 3 to 13 of the Periodic Table.

4. The ozone generator device according to claim 3, wherein the cathodes are made of or plated with palladium, palladium alloys, magnesium alloys, or titanium alloys.

5. The ozone generator device according to claim 1, further including on the second surface of the printed circuit board another thin film heating element connected to the power supply.

6. The ozone generator device according to claim 1, further including a second ozone producing circuit printed on the second surface, the second ozone producing circuit being identical to the ozone producing circuit printed on the first surface.

7. The ozone generator device according to claim 1, further including a plurality of lights or light emitting diodes fixed on the printed circuit board and also connected to the power supply, the lights or light emitting diodes producing a light with a wavelength from 1 to 600 nm, wherein the light facilitates the purification of water by ozone.

8. An ozone generator device for purifying water, the device including:
a printed circuit board having a first and second surface;
a power supply device exterior to the printed circuit board;
an ozone producing circuit printed on the first surface of the printed circuit board, the ozone producing circuit including a plurality of anodes and cathodes that are alternatively printed on the printed circuit board and being connected in parallel relationship to each other, the anodes and cathodes having non-smooth surfaces, the ozone producing circuit being linked to the power supply device via electric wires; and
on the first surface of the printed circuit board, underneath the ozone producing circuit, a thin film heating element connected to the power supply;
wherein, when the ozone generator is plunged in a vessel containing water to be purified, the cathodes produce hydrogen bubbles and the anodes produce ozone and mixed oxidants; and
wherein, due to the non-smooth surfaces, the cathodes lead to a coalescence of the hydrogen hubbies into larger hydrogen bubbles, and thus to a higher production of ozone.

9. The ozone generator device according to claim 8, wherein the power supply device includes at least a battery and/or at least a silicon solar panel, fixed on one of the surfaces of the printed circuit board.

10. The ozone generator device according to claim 8, wherein the power supply device includes a plurality of galvanic cells printed on another printed circuit board and connected in series relationship to each other.

11. The ozone generator device according to claim 10, wherein the galvanic cells are made of metal combinations selected from Pt/Al, Pt/Ti, Pt/Mn and Pt/Mg.

12. The ozone generator device according to claim 8, wherein the power supply device is a battery, a plurality of batteries, an electric transformer alimented by a public electric system or an individual electric system.

13. The ozone generator device according to claim 12, wherein the individual electric system is a solar panel or a windmill.

14. The ozone generator device according to claim 8, wherein the anodes and cathodes are made of or plated with metals or alloys of the metals selected from columns 3 to 1.3 of the Periodic Table.

15. A method for purifying water including the steps of:
a) plunging into water to be purified the ozone generator device as defined in claim 1, and
b) waiting for an adequate period of time in order to let the ozone generator device producing ozone and purifying the water.

16. A method for purifying water including the steps of:
a) plunging into water to be purified the ozone generator device as defined in claim 10;
b) plunging the power supply of the ozone generator device in another vessel containing an electrolyte solution; and
c) waiting for an adequate period of time in order to let the ozone generator device producing ozone and purifying the water.

17. A method for purifying water including the steps of:
a) plunging into water to be purified the ozone generator device as defined in claim 12;
b) turning on the power supply connected to the ozone producing circuit of the ozone generator device; and
c) waiting for an adequate period of time in order to let the ozone generator device producing ozone and purifying the water.

18. A bottle for purifying water, the bottle including:
an internal volume and a separating wall to separate the internal volume into a top volume containing water to be purified and a bottom volume containing an electrolyte solution, and
an ozone generator device as defined in claim 1, the ozone generator device being inserted through the separating wall, the separating wall having a hole sized to fit the ozone generator device, the ozone producing circuit being into the top volume of the bottle and the power supply device being into the bottom volume.

19. The bottle according to claim 18, wherein the separating wall is a membrane allowing the water to go through the membrane and maintaining salts of the electrolyte solution into the bottom volume.

20. A bottle for purifying water, the bottle having an internal volume and a bottom, and including a compartment fixed to the bottom and hermetically separated from the internal volume of the bottle containing water to be purified, the compartment containing a power supply connected to the ozone producing circuit of the ozone generator device as defined in claim 12.
